(19) United States
(12) Patent Application Publication
(10) Pub. No.: US 2006/0170773 A1
(43) Pub. Date: Aug. 3, 2006

(54) Wireless multi-camera surveillance system

(75) Inventors: David John Rye, Kent, WA (US); Lesley Alan Leech, Kowloon (HK)

Correspondence Address: Marvin N. Gordon, 277 West End Avenue, New York, NY, 10023, US

(73) Assignee: X10 Ltd.

(21) Appl. No.: 11/044,832

(22) Filed: Jan. 28, 2005

(51) Int. Cl. H04N 7/18; H04N 9/47

(52) U.S. Cl. 348/159; 348/143

(57) ABSTRACT

A wireless multi-camera home surveillance system includes a plurality of video cameras located at different locations in and around the home. The cameras are respectively connected to a plurality of wireless addressable rf receivers which receive over-the-air binary-coded rf address signals from a remote control unit. The addressed receiver applies an operating voltage to its associated camera to turn it on while all other cameras, including any previously on camera, are turned off.

### BACKGROUND OF THE INVENTION

1. Field of the Invention

The present invention relates generally to surveillance systems, and more particularly to a wireless system for monitoring a plurality of different, spaced locations in a home, office or similar installation at a single viewing station.

2. Description of the Prior Art

As described, for example, in U.S. Pat. No. 6,744,463 granted to the inventors herein and assigned to a common assignee herewith, the use of video cameras to monitor the comings and goings of individuals in a public building or multi-dwelling building has become widespread in recent years. In a security installation of this nature, video cameras are installed at various locations in the building. The video outputs of these cameras are coupled respectively to a corresponding plurality of television receivers at a single security station at which the images derived from these cameras can be viewed by a security officer who is thus able to view and monitor events occurring at the time at each of the monitored locations.

Less common has been the use of video cameras to monitor different, spaced locations in and outside a private residence, such as a single-family home. In a typical home security system, a video camera mounted at a location in the home, such as near the front door, transmits images from that location to allow the homeowner to view from a safe distance who is at the front door, or, from other camera locations, to view, for example, events occurring in an outdoor pool or in a child's nursery. The use of video cameras in home security systems has been on the increase in recent years, primarily as a result of the decreasing cost and size of video equipment and the rise in concerns about security.

As also described in the aforesaid U.S. Pat. No. 6,744,463, in order to increase the use of video cameras in a home surveillance security system, it is desirable to be able to view the images derived from a plurality of cameras located at different spaced locations that are of primary concern to the homeowner on a single, conveniently located television receiver. This arrangement, however, requires that the video camera that is then on be turned off before, or at the same time, a video camera at a different location is turned on. Otherwise the television receiver would receive images from two or more cameras which are on at the same time, which would result in an unusable, garbled image. There has thus been a need for an improved, reliable and yet affordable multi-camera home surveillance security system that employs a plurality of spaced, remote video cameras that transmit video images to a single receiver at which images from only one of the cameras is viewed at a single receiver at any given time.

The multi-camera surveillance system described in U.S. Pat. No. 6,744,463 is one recent attempt to meet this need. As therein shown, a number of video cameras are located at different, spaced locations around the home. The cameras are selectively turned on and off by addressable control modules operatively connected to the cameras, which function to turn off a previously on camera when a previously off camera is turned on. In this manner, only one camera is on at any time.

The multi-camera surveillance system described in this prior patent is generally effective in providing a reliable home security system in which only a selected one of a plurality of video cameras is turned on at any given time, while all of the other cameras in the system are turned off. This system is, however, relatively high in cost, which has thus far limited its acceptance and use by home owners. Moreover, since this patented system makes use of the home ac power line to transmit the binary-coded control signals to the control modules to turn the cameras on and off, there may be occasions in which these control signals do not get to the control modules because of possible power line limitations such as noise, phase coupling issues, and the like. Further the connection of control modules to the ac power line in this prior system limits the user's flexibility in selecting locations in the home at which the video cameras may be placed.

### SUMMARY OF THE INVENTION

It is accordingly an object of the present invention to provide an improved multi-camera home surveillance system in which only one of the multiple cameras in the system is able to send an image at any given time to a central receiver, which overcomes the limitations and potential problems associated with the prior art systems of this type.

It is a further object of the present invention to provide an improved home surveillance system of the type described that reliably allows images from any selected one of a plurality of spaced locations in and around the home to be viewed at a single viewing station.

It is another object of the present invention to provide a home surveillance system of the type described in which the user has greater flexibility in positioning the video cameras and in which the system may receive its operating voltages from a simplified power supply such as a battery.

To these ends, the home surveillance system of the present invention includes at least one group consisting of, for example four, video cameras and associated video transmitters positioned at selected different locations in and around the home. Each of the cameras is selectively operable, i.e., turned on and off, by the operation of a remote control unit, which sends a binary-coded address signal to turn on a previously off camera, and to also turn off a previously on camera, so that, as desired, only one of the plurality of spaced cameras is on at any given time.

In the multi-camera surveillance system disclosed in the aforesaid US Patent, the binary-coded control signals are transmitted along the home ac power line to a plurality of addressable controllable power supplies or modules, which are respectively connected to the video cameras to control their operation in response to the received address and control signals. In contrast, in the system of the present invention, the power supplies are not addressable and need not be connected to the ac power line. Instead a wireless, addressable rf receiver is connected intermediate each of the power supplies and their associated video cameras.

When one of these addressable rf receivers receives an over-the-air binary-coded rf signal that contains its address and its group code, it applies an operating voltage from its associated power supply to turn on its associated camera. Any other addressable rf receiver in that group that receives an over-the-air binary-coded rf signal that contains its group code but not its address or unit code, removes the operating voltage from its associated power supply, thereby to turn off its associated camera. In this manner only one camera in the group is on at any given time.

In another feature of the present invention, the wireless receiver's unique address is stored in the receivers by transmitting its binary address code from a remote rf transmitter a predetermined number of times, e.g., three times, within a specified time, e.g. 30 seconds after applying power, so that the address received and decoded at the receiver becomes stored in a permanent memory contained in the receiver. This address is thus “remembered” by the receiver even if there is a future power failure or outage. The address of the receiver can thereafter be changed by disconnecting the receiver from its associated power supply, reconnecting it to the power supply, and then sending the new address code the specified number of times within the specified time period after applying power.

To the accomplishment of the above and such further objects as may hereinafter appear, the present invention relates to a wireless multi-camera home surveillance system, substantially as defined in the appended claims as considered in conjunction with the following detailed description of a preferred embodiment thereof along with the accompanying drawings in which:

### BRIEF DESCRIPTION OF THE DRAWINGS

FIG. 1 is a schematic diagram of a wireless multi-camera surveillance system in accordance with an embodiment of the invention;

FIG. 2 is a schematic block diagram of a wireless addressable receiver that may be employed in the surveillance system of FIG. 1; and

FIG. 3 is a logic flow chart describing the operation of the surveillance system of FIG. 1.

### DETAILED DESCRIPTION OF THE PREFERRED EMBODIMENT

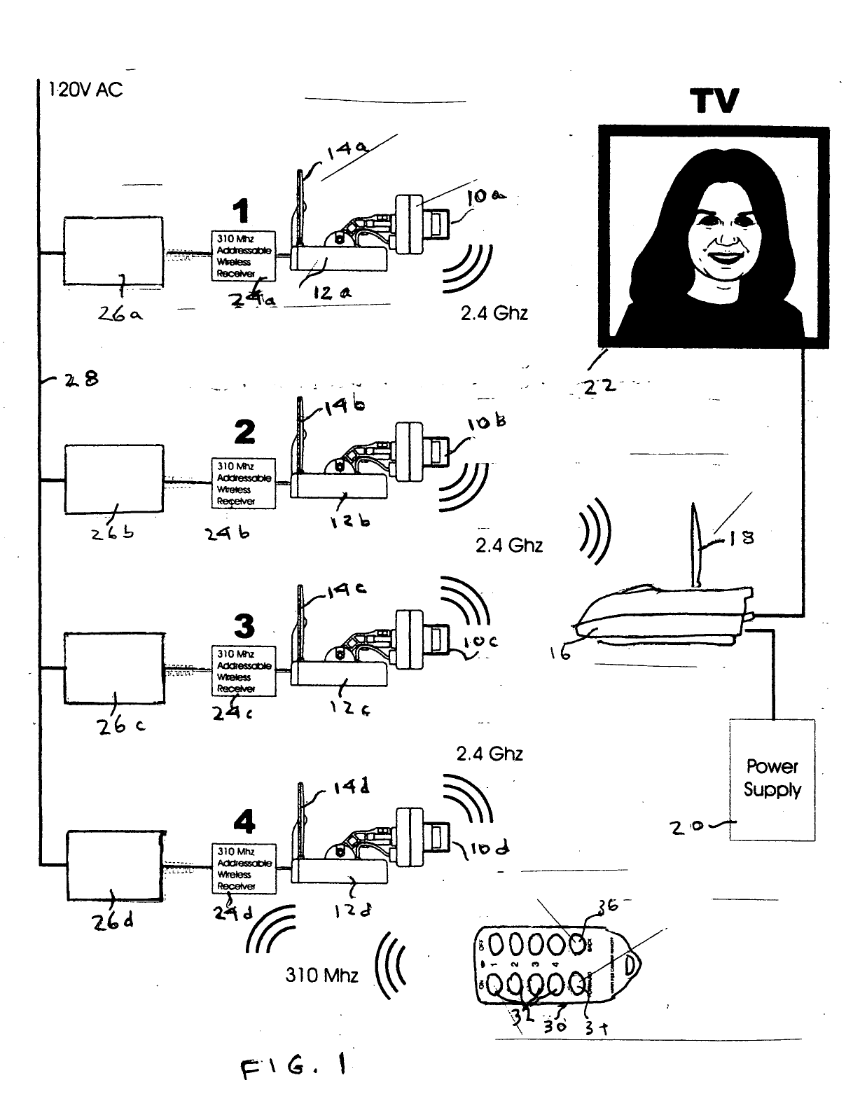

As illustrated in FIG. 1, a group of television or video cameras 10a-10d, here shown for purposes of example only as being four in number, are positioned at various selected, spaced locations in and around a home. One of the cameras 10 may be situated, for example, in a baby's room and another by a pool. Each camera 10 is preferably a miniaturized color video camera that preferably can be manually or mechanically moved through an arcuate path to enable it to scan over a relatively large area.

The video signal produced by each camera, when it is turned on in the manner described in greater detail in a later part of this specification, is applied to its associated 2.4 GHz wireless video sender 12a-12d to which is also respectively connected a 2.4 GHz patch antenna 14a-14d. The video sender 12 to which the then on video camera is connected transmits a video rf signal from its patch antenna at a typical frequency of 2.4 GHz to a 2.4 GHz video rf receiver 16, which receives that signal at its own patch antenna 18. Video receiver 16, which receives its operating voltage from a power supply 20, has its output connected to a conventional television receiver 22 to which video receiver 16 may be mounted and secured. It will be understood that the video rf signals may be at other frequencies, such as 900 MHz.

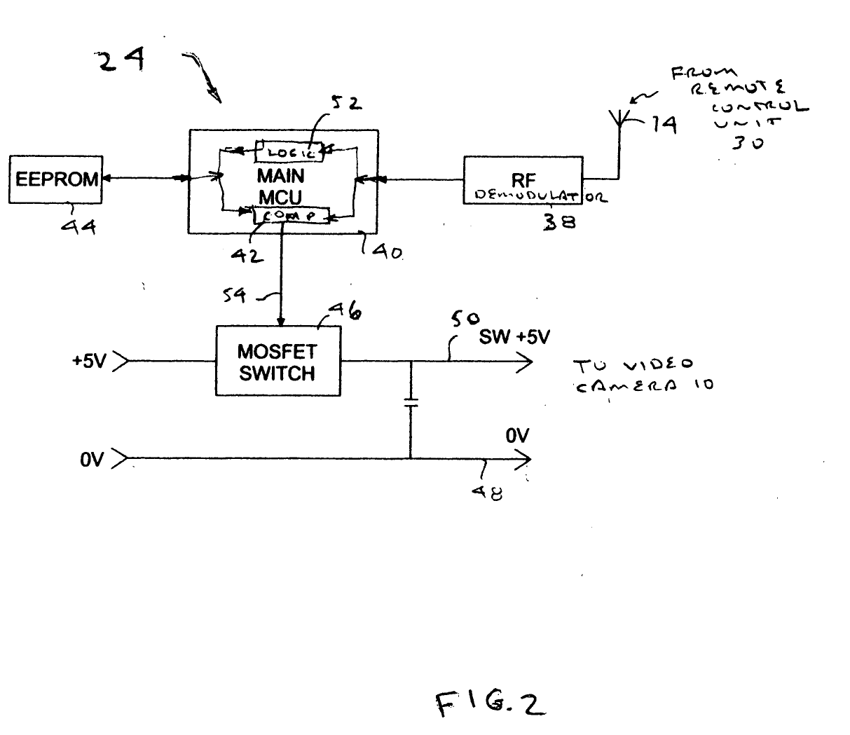

In accordance with the present invention, and in contrast to the multi-camera surveillance system described in the aforesaid US Patent, video senders 12a-d are respectively connected to the outputs of a group of addressable wireless rf receivers 24a-24d, which are described in greater detail below with reference to FIG. 2. Each wireless receiver 24 also has an input connected to an otherwise conventional dc power supply 26. Power supplies 26a-d may, in turn, be connected, as shown, to the home ac power line 28 in which case the power supplies 26 would include conventional circuitry to convert the 120 ac voltage on line 28 to a 5-volt dc output. If desired, the connection of the power supplies 26 to the ac power line 28 may be eliminated, in which case the power supplies 26a-d could each be a conventional 9-volt dc supply such as a battery.

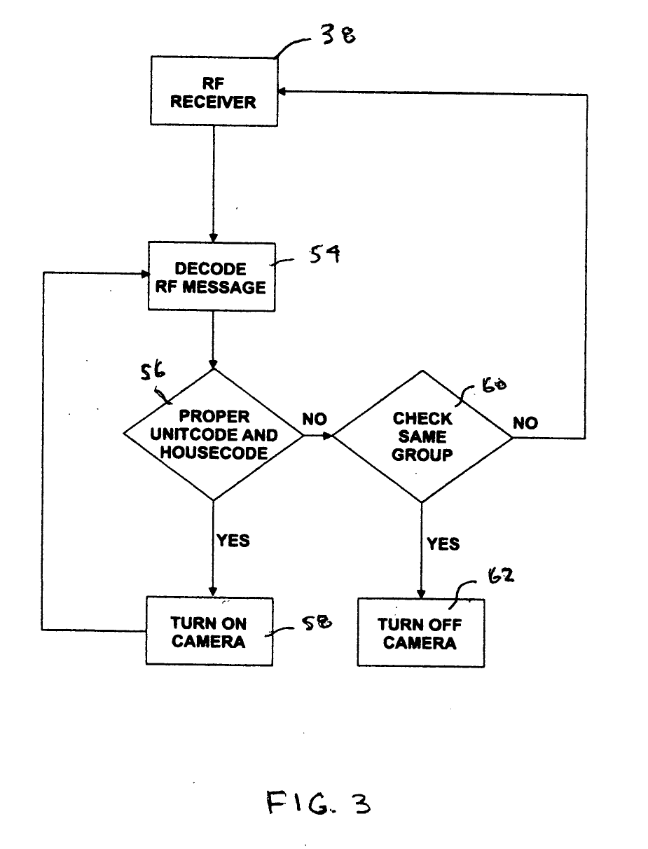

In the operation of the wireless multi-camera surveillance system of FIG. 1, as also described below with reference to FIG. 3, the user selects which location in or around the home he/she wishes to monitor by operating a remote control unit 30 to cause only the camera 10 at that location to be actuated or turned on so that only the image at that location will be viewed at receiver 22. To this end, the user presses one of the select buttons 32 on the remote control unit 30 that is associated with the camera at the selected location, it being understood that each of buttons 32 is uniquely associated with one of the camera locations. The pushing of the selected button 32 causes, in a known manner, remote control unit 30 to generate and transmit a binary-coded rf signal at a typical frequency of 310 MHz, that includes a binary unit code, which corresponds to the unique address of the wireless addressable receiver 24 connected to the selected camera 10. The rf binary-coded signal transmitted from the remote control unit 30 also includes the house code that is common to all receivers 24 and cameras 10, and a group code that is common to a given group of receivers and cameras.

As described in greater detail below, the thus-transmitted binary-coded rf address signal is detected at the patch antennas 14 associated with each of the addressable wireless receivers 24. The received rf address signal is demodulated and the detected binary-coded address signal is processed in the receivers 24 to compare the received address code against the unique address codes stored respectively in memories in each of the group of addressable rf receivers 24.

The received binary-coded address includes a unit code that is unique for each of the addressed rf receivers 24, a group code that is common to all rf addressable receivers 24 in a common group, and a house code that is common to all rf addressable receivers 24 within the home. At the addressable rf receiver 24 for which a match between the stored and detected unit, group and house codes is detected, switching means in the addressable rf receiver 24 is actuated to apply an operating voltage received from its associated power supply 26 to the video camera 10 to which that receiver is connected, thereby to turn that camera on. The other receivers 24 at which no match is detected between the received and stored binary unit codes, but which are part of the group of four receivers, will not couple an operating dc voltage to the video cameras 10 to which those non-addressed receivers 24 are respectively connected, so that those other non-selected cameras will remain off, or if any one of them was previously on, it will no longer receive an operating voltage and will thus be automatically turned off.

Thus, for example, if the camera 10a is on and the user wishes to view the area covered by camera 10b, the user will press button 2 on control unit 30 to transmit a binary-coded rf signal that contains the binary-coded unit address of receiver 24b. The detection of that binary address signal will cause wireless receiver 24b only to apply a 9-volt dc operating voltage to camera 10b to turn it on. At the same time receiver 24a will switch off the 9-volt dc supply to previously on camera 10a, thereby to automatically turn camera 10a off, and leave only one camera, here camera 10b, on, as desired. Previously off cameras 10c and 10d will continue not to receive an operating voltage from receivers 24c and 24d respectively, and will thus remain off.

As shown in FIG. 2, each of the rf addressable wireless receivers 24 includes the 2.4 GHz patch antenna 14 that is connected to an rf demodulator 38 that detects the received binary address code and applies it to an input of a resident microprocessor or MCU 40. The latter includes a comparator 42 to which the decoded binary address unit code signal, as well as the group and house codes obtained at demodulator 38, are applied at one of its inputs. The other input of comparator 42 receives the unique address unit code for that receiver 24 that is stored in a memory, here shown as an electrically erasable programmable read-only memory (EEPROM) 44, which also has stored therein the appropriate group and house codes for that receiver. The output of comparator 42 is connected to the control terminal of a switching device, here shown as a MOSFET switch 46, which receives at its input terminal the 9-volt dc voltage supply from power supply 26. The receiver 24 also receives a 0 volt line 48, and that line, in addition to the output line 50 of switch 46, is applied to the control input of the video camera 10. Receiver 24 also includes a logic circuit 52 having an input connected to the output of demodulator 38 and an output connected to the EEPROM 44.

In the operation of the system of FIGS. 1 and 2, as also described in the flow chart of FIG. 3, the detected binary unit address code and the group and house codes are all applied to an input of comparator 42 in MCU 40. If and when comparator 42 detects a match between the received address unit code, and the receiver's unique address unit code, as well as the group and house codes stored in memory 44, it sends an address detect signal on a line 54 to turn FET 46 on, thereby to apply the input 9-volt dc signal to the video camera 10 to which that receiver 24 is connected to turn that camera on. For example, if receiver 24a receives a matching address signal, it will supply an operating voltage to its associated video camera 10a. All other cameras, here cameras 10b-10d, will receive only the 0 volt signal and thus will be turned off, if previously on, or, if they are already off, will remain off.

Stated differently, in an addressable rf receiver 24 receives a binary code that matches its house code, its group code and its unit code, it applies an operating voltage to its associated camera 10 to turn it on. If an rf receiver 24 receives a binary code that matches its house code and its group code, but not its unit code, it acts to remove the operating voltage from its associated camera to turn it off. Thus only one receiver and its associated camera in the group of four is turned on at any given time. If an addressable rf receiver 24 receives a binary-coded address that does not match its house code or its group code it ignores the received code and does nothing in response thereto.

The address or unit code, as well as the group code stored in EEPROM 44 may be set or modified by operation of the remote control unit 30. To set or modify the address of any of the receives 24, the user presses the button 32 associated with the receiver 24 for which a new address is desired, say button 1 for receiver 24a, a predetermined number of times, e.g. 3, within a predetermined time from applying an operating voltage, e.g. 30 seconds. The detected binary address code received from unit 30 is applied to one input of logic circuit 52. When the new address is detected in logic circuit 52, the new binary-coded receiver address is applied to its EEPROM 44 to erase any previously stored address and write in the new address. The design of logic circuit 52 to perform this function, that may include conventional timer and counter circuits, is believed to be within the skill of the average logic designer and is thus not further described herein. The new address thus stored in memory 44 is remembered, that is, remains stored in the memory even if there is a power outage or failure. That address can be changed by unplugging the power supply 26 and then plugging it back into an ac outlet and then sending a new address code to the receiver a preselected number of times within the preset time period after applying power.

As noted above, each of the addressable rf receivers 24 in a group has stored in its resident memory 44 a common group code that, in addition to that receiver's unique address unit code, identifies that particular receiver as being included in a designated group of addressable rf receivers. In this arrangement, the binary-coded address signal that is received by the receiver 24 from the remote control unit 30 includes the group code as well as the address of the selected or addressed receiver. In response to the receipt of this signal, the thus-addressed receiver 24 will supply an operating voltage to its associated receiver while all other cameras in that group are turned off.

Referring now to FIG. 3, the operation of MCU 40 begins with the rf message signal from the remote control unit 30 being decoded as indicated at 54 to derive the transmitted binary unit, group and house codes. As described above, if a match is detected as indicated at 56 between the house, unit and group codes stored in memory 44 and the detected house, unit and group codes, the camera 10 identified by that unit code is turned on, in the manner described above, as indicated at 58.

If a match is detected as indicated at 56 between the house and group codes but not the unit code stored in memory 44 and the received and detected house and group codes, the camera 10 identified by that unit code is turned off, in the manner described above, as indicated at 58. If no match is detected at 56 between the house or group code stored in memory 44 and the received and detected house or group code, respectively, the code is ignored.

The program operation returns to decode the next received rf address message at 54. All other cameras in the group to which the selected, turned on camera belongs, that is, those cameras that share the same house and group codes as the selected camera but for which their respective unit codes are not detected at 56, are checked as indicated at 60 to determine if they belong to that group. For a positive determination at 60 those other cameras are all turned off as indicated at 62. For a negative determination at 62, that the cameras do not belong to the group of the selected camera or do not match the transmitted house code, the program is returned to step 38 to begin a new operation on the next received coded rf message from the remote control unit 30.

If the group code sent to any of the wireless rf receivers 24 in a given group is not the group code for that group of receivers, such as when the group code is intended to operate a camera in another group of cameras, all of the four receivers in that group will ignore that signal and remain unaffected, that is, they stay off if they were off, or stay on if they were on

As can be seen in FIG. 1, the remote control unit 30 includes two sets of camera-select buttons 1-4 and 5-8. The former group of buttons is intended to operate the cameras in a first group, and if any of these buttons is pressed, an address signal containing its common group code along with the unique address for one of the four cameras in that group is transmitted. Similarly, pressing any of buttons 5-8 will produce a binary-coded rf signal that includes a second, different common group code and the address of one of the wireless, addressable receivers 24 in that second group. As a result, only the selected one of four cameras in the second four-camera group is turned on. The remote may include four different groups of push buttons such as 1-4, 5-8, 9-12, and 13-16.

Remote control unit 30 may also transmit binary-coded rf signals that will cause the sequential on-off operation of the cameras within a group or in more than one group. Thus, for example, the address signal sent over-the-air to the receivers 24 may turn one of the previously on cameras, say camera 10a, off and turn camera 10b on; thereafter, following a short period, e.g. 5 seconds, camera 10b is turned off and camera 10c is turned on. This process continues automatically as long as desired in either direction, e.g. either forward or reverse. To achieve this scanning process, the remote control unit 30 is provided with a forward scan button 34 and a reverse scan button 36, whose operation respectively causes the sequence of camera scanning to occur either in a forward sequence, cameras 10a, 10b, 10c, and 10d, or a reverse sequence of cameras 10d, 10c, 10b, and 10a. In this manner, the user is able to automatically and sequentially view events occurring at all the different location at which a camera 10 is provided.

It will be appreciated from the foregoing description of a presently preferred embodiment that the present invention, as described hereinabove, allows the user to monitor a plurality of spaced locations in and around a home in an efficient and reliable manner. It will also be appreciated by those of ordinary skill in the art that modifications may be made to the embodiment specifically described above without necessarily departing from the spirit and scope of the invention.

What is claimed is:

1. A multi-location wireless video surveillance system comprising: at least a first group of video cameras adapted to be located at a plurality of locations, means respectively operatively connected to said group of cameras for transmitting video signals derived from said cameras to a television receiver, at least a first group of addressable rf receivers respectively operatively connected to said group of video cameras, each of said addressable rf receivers having a unique address and being effective upon receipt of a binary-coded signal that includes its unique unit code to apply an operating voltage to the one of said cameras to which it is operatively connected, thereby to turn said one of said cameras on, said binary-coded signal also being received by the other non-addressed ones of said addressable rf receivers in said group from which no operating voltages are then applied to the others of said cameras to which the non-addressed receivers are operatively connected, whereby said others of said cameras in said group are off and any previously on one of said other cameras in said group is turned off.

2. The multi-camera surveillance system of claim 1, in which each of said addressable rf receivers includes means for storing a unique binary unit code, means for comparing the decoded received unit code and its said stored unit code, and switch means operatively connected to said comparing means for applying an operating voltage to the one of said cameras connected to said receiver upon the detection of a predetermined relation between said detected received unit code and said stored unit code.

3. The multi-camera surveillance system of claim 1, further comprising a plurality of voltage sources respectively operatively connected to said addressable rf receivers, said addressed addressable receiver being effective when it detects its unit code to apply an operating voltage derived from the one of said voltage sources to which it is operatively connected to the one of said cameras to which it is operatively connected.

4. The multi-camera surveillance system of claim 3, in which each of said addressable rf receivers includes means for storing a unique binary unit code, means for comparing the decoded received unit code and its said stored unit code, and switch means operatively connected to said comparing means for applying said operating voltage to the one of said cameras connected to said receiver upon the detection of a predetermined relation between said detected received unit code and said stored unit code.

5. The multi-camera surveillance system of claim 2, in which each of said addressable rf receivers in said first group further includes a stored group code that is common to a said first group of addressable rf receivers, said transmitted binary-coded address signal also including a group code.

6. The multi-camera surveillance system of claim 5, in which each of said addressable rf receivers has further stored therein a common house code, said transmitted binary address signal also including said house code.

7. The multi-camera surveillance system of claim 4, in which the one of said addressable rf receivers that receives a matching house code, group code and unit code applies an operating voltage to its associated camera so that said camera is turned on, and each of said other addressable rf receivers in a common group with said one of said receivers that receives a matching house code and group code, but not a matching unit code, removes an operating voltage from their respectively associated camera so that said other cameras are all turned off.

8. The multi-camera surveillance system of claim 7, in which the ones of said addressable rf receivers in a common group that receive a binary address signal that does not include a matching group code, and their respectively associated cameras, remain in the on or off condition they were respectively in before the receipt of said binary address signal.

9. The multi-camera surveillance system of claim 7, further comprising a second group of cameras and a second group of addressable rf receivers each having a unique unit code and a second common group code different from said first-mentioned group code operatively respectively connected to said second group of cameras

10. The multi-camera surveillance system of claim 2, in which each of said addressable receivers comprises a memory and logic means for entering a unit code into said memory upon the receipt of a preselected number of said unit codes during a preset time period after applying power.
